(19) United States
(12) Patent Application Publication
(10) Pub. No.: US 2013/0199003 A1
(43) Pub. Date: Aug. 8, 2013

(54) CLIP

(71) Applicant: DAIWA KASEI KOGYO KABUSHIKI KAISHA, Okazaki-shi (JP)

(72) Inventors: Toshio IWAHARA, Okazaki-shi (JP); Jun KOMENO, Okazaki-shi (JP)

(73) Assignee: DAIWA KASEI KOGYO KABUSHIKI KAISHA, Okazaki-shi (JP)

(21) Appl. No.: 13/756,150

(22) Filed: Jan. 31, 2013

(30) Foreign Application Priority Data
Feb. 3, 2012 (JP) 2012-021807

(51) Int. Cl. F16B 2/22

(52) U.S. Cl. CPC F16B 2/22
USPC 24/530

(57) ABSTRACT

A clip may be configured to be coupled to an attachment portion formed in an attaching component and configured to be inserted into an attaching hole formed in a panel. The clip may include a closed front end, an open rear end, an engagement member extended from the front end of the clip toward the rear end of the clip and having a proximal end portion corresponding to the front end of the clip and a distal end portion corresponding to the rear end of the clip, and a retainer members formed in the engagement member and configured to be secured to the attachment portion of the component. The engagement member includes a main portion having an outwardly bulged portion, a transition portion obliquely extended inwardly from the outwardly bulged portion of the main portion, and an arm portion extended from the transition portion.

### BACKGROUND OF THE INVENTION

1. Field of the Invention

The present invention relates to a clip for attaching an attaching article or component (e.g., a center cluster, one of automobile interior parts) to an object member (e.g. an instrument panel).

2. Description of Related Art

This type of clip is already known. The known clip is composed of a pair of engagement members and a pair of retainer members. The engagement members are connected to each other at respective end portions thereof so as to have a U-shape as a hole. The retainer members are formed as a pair of flexible strips that are respectively formed in the engagement members. Further, the engagement members are respectively capable of elastically flexing about the connected end portions thereof. Further, the engagement members respectively have outwardly most-bulged portions so as to form shoulder portions therein.

In order to attach a component (an attaching article) to a panel (an object member), the clip is coupled to an attachment portion formed in a rear surface of the component using the retainer member. Thereafter, the engagement members of the clip are pushed into an attaching hole formed in the panel. As a result, the engagement members are introduced into the attaching hole while elastically flexing inwardly. When the outwardly most-bulged portions of the engagement members pass through the attaching hole, the engagement members are restored or flexed outwardly, so that the shoulder portions engage a periphery of the attaching hole. As a result, the engagement members are securely received in the attaching hole, so that the clip can be connected to the panel. Thus, the component can be attached to the panel via the clip.

Further, various clips improved upon the clip described above have been developed. For example, improved clips are taught, for example, by Japanese Laid-Open Patent Publications Nos. 2009-97521 and 2009-8138 and Japanese Patent No. 4540726. In each of the clips taught by Japanese Laid-Open Patent Publications Nos. 2009-97521 and 2009-8138 and Japanese Patent No. 4540726, the engagement members are configured so as to contact the attachment portion of the component due to elastic deformation thereof when an extraction force is applied to the clip attached to the panel. As a result, the clip may have an increased retaining (resisting) force against the extraction force. Further, each of the clips taught by Japanese Laid-Open Patent Publication No. 2009-8138 and Japanese Patent No. 4540726 is configured such that the retaining force thereof can be changed by changing the shape of the attachment portion of the component which contacts the engagement members.

Also, a clip 110 shown in FIGS. 8(A) to 8(H) is known. The clip 110 has front and rear ends and has a U-shape as a hole. The clip 110 is composed of a pair of engagement members 112 and a pair of retainer members 114. The engagement members 112 may have proximal end portions 112a and distal end portions 112b. The engagement members 112 may be connected to each other at the proximal end portions 112a thereof The retainer members 114 are formed as a pair of flexible strips that are respectively formed in the engagement members 112. The flexible strips are oppositely convexed inwardly. Further, the engagement members 112 are respectively capable of elastically flexing about the connected proximal end portions 112a. Further, the engagement members 112 respectively have outwardly most-bulged portions that can form shoulder portions 112c therein. The engagement members 112 may be relatively thinned and inclined inwardly from the shoulder portions 112c toward the distal end portions 112b, so as to form arm portions 112e.

In order to attach a component (an attaching article) to a panel 24 (an object member), the clip 110 is coupled to an attachment portion 22 formed in a rear surface of the component using the retainer member 114. Thereafter, the engagement members 112 of the clip 110 are pushed into an attaching hole 26 formed in the panel 24. As a result, as shown in FIGS. 8(A) to 8(G), the engagement members 112 are introduced into the attaching hole 26 while they are elastically flexed inwardly. As shown in FIG. 8(H), when the outwardly most-bulged portions of the engagement members 112 pass through the attaching hole 26, the engagement members 112 are restored or flexed outwardly, so that the shoulder portions 112c can engage a periphery of the attaching hole 26. As a result, the engagement members 112 can be securely received in the attaching hole 26, so that the clip 110 can be connected to the panel 24. Thus, the component can be attached to the panel 24 via the clip 110.

As shown in FIGS. 8(D), in the clip 110, the engagement members 112 are configured such that the distal end portions 112b thereof can contact the attachment portion 22 of the component when the clip 110 is inserted into the attaching hole 26 over a predetermined distance (i.e., a predetermined insertion stroke). Further, as shown in FIGS. 8(E) to 8(H), the engagement members 112 are configured to be introduced into the attaching hole 26 while the distal end portions 112b thereof continuously contact the attachment portion 22 until the shoulder portions 112c engage the periphery of the attaching hole 26 when the clip 110 is further inserted into the attaching hole 26.

The clip 110 may have a substantial retaining force. However, in the clip 110, when the clip 110 is pushed into the attaching hole 26, an insertion resistance can be largely varied. In other words, an increased insertion load (force) of the clip 110 can be largely varied. In particular, a characteristic curve of the insertion load of the clip 110 may have a peak therein. As a result, workers may be overburdened. This may lead to reduced working efficiency of a clip insertion operation.

Thus, there is a need in the art for improved clips.

### BRIEF SUMMARY OF THE INVENTION

For example, in one aspect of the present invention, a clip made of resin may be provided. The clip may be configured to be coupled to an attachment portion formed in an attaching component and configured to be inserted into an attaching hole formed in a panel, so as to attach the component to the panel. The clip may include a closed front end that functions as a leading end when the clip is inserted into the attaching hole, an open rear end, an engagement member extended from the front end of the clip toward the rear end of the clip and having a proximal end portion corresponding to the front end of the clip and a distal end portion corresponding to the rear end of the clip, and a retainer member formed in the engagement member and configured to be secured to the attachment portion of the component. The engagement member has an outwardly bulged portion that is positioned between the proximal end portion and the distal end portion thereof so as to form a shoulder portion therein, and an arm portion that is positioned between the shoulder portion and the distal end thereof. The engagement member is configured to be elastically deformed inwardly about the proximal end portion. The engagement member is configured such that when the engagement member is introduced into the attaching hole of the panel, the distal end portion and the arm portion thereof can successively contact the attachment portion of the component due to elastic deformation of the engagement member before the shoulder portion of the engagement member passes through the attaching hole. The engagement member is configured to engage a periphery of the attaching hole when the shoulder portion of the engagement member passes through the attaching hole.

Optionally, the engagement member may be configured such that the arm portion can continuously contact the attachment portion of the component until immediately before the shoulder portion of the engagement member passes through the attaching hole.

According to the aspect of the present invention, when the engagement member is introduced into the attaching hole of the panel, the distal end portion and the arm portion thereof can successively contact the attachment portion of the component before the outwardly bulged portion of the engagement member passes through the attaching hole. Therefore, an elastic force of the engagement member (which substantially corresponds to a retaining force of the clip) can be maintained substantially constant during a clip insertion operation. As a result, an insertion load of the clip can be maintained substantially constant over the substantially all insertion strokes without reducing the retaining force of the clip. Therefore, workers can be prevented from being overburdened.

Other objects, features and advantages of the present invention will be readily understood after reading the following detailed description together with the accompanying drawings and the claims.

### BRIEF DESCRIPTION OF THE DRAWINGS

FIG. 1 is a perspective view of a clip according to a first embodiment of the present invention, an attaching component and a panel, which illustrates a condition in which the component is not attached to the panel using the clip;

FIG. 2 is an enlarged perspective view of the clip;

FIG. 3 is an elevational view of the clip;

FIG. 4 is a side view of the clip;

FIGS. 5(A) to 5(H) are explanatory views of the clip, which respectively illustrate first to eighth stages of a clip insertion operation;

FIG. 6 is a diagram illustrating characteristics of the clip;

FIG. 7 is an elevational view of a clip according to a second embodiment of the present invention; and

FIGS. 8(A) to 8(H) are explanatory views of a conventional clip, which respectively illustrate first to eighth stages of a clip insertion operation.

### DETAILED DESCRIPTION OF THE INVENTION

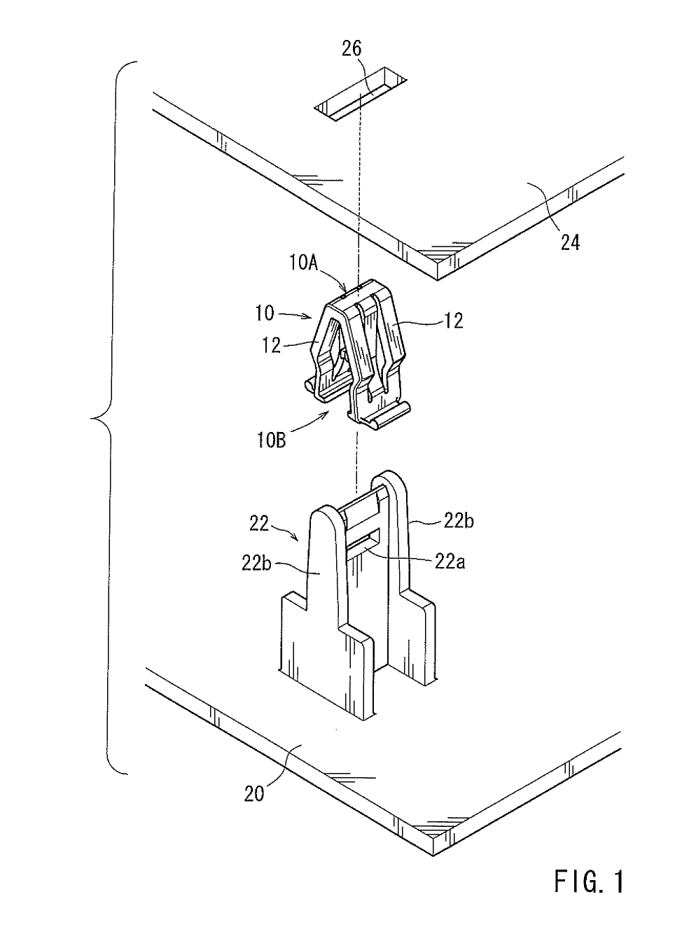

Detailed representative embodiments of the present invention are shown in FIGS. 1 to 7.

A first detailed representative embodiment of the present invention will be described with reference to FIGS. 1 to 6.

As shown in FIG. 1, the present embodiment is directed to a clip 10 that is used to attach a component 20 (an attaching article) to a panel 24 (an object member). In particular, the clip 10 is configured so as to be coupled to an attachment portion 22 formed in the component 20. Further, the clip is configured so as to be inserted into an attaching hole 26 formed in the panel 24. Upon insertion of the clip 10 into the attaching hole 26 after the clip 10 is coupled to the attachment portion 22 of the component 20, the component 20 can be attached to the panel 24.

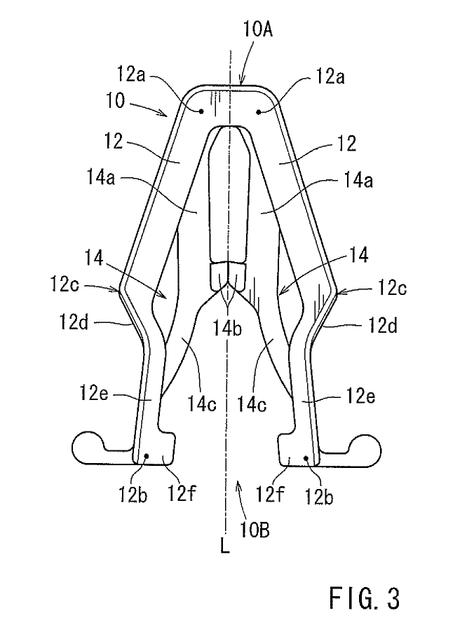

The clip 10 may preferably be integrally formed by resin molding. As best shown in FIG. 3, the clip 10 may have a U-shape as a hole. That is, the clip 10 thus shaped may have a closed upper or front (leading) end 10A which functions as a leading end when the clip 10 is inserted into the attaching hole 26 of the panel 24 and an open lower or rear (trailing) end 10B from which the clip 10 is coupled to the attachment portion 22 of the component 20. In particular, the clip 10 may essentially be composed of a pair of right and left flexible engagement members 12 and a pair of flexible retainer members 14. The engagement members 12 may be configured to be introduced into and connected to the attaching hole 26 of the panel 24, so as to attach the clip 10 to the panel 24. Conversely, the retainer members 14 may be configured to be secured to the attachment portion 22 of the component 20, so as to couple the clip 10 to the attachment portion 22 of the component 20.

As shown in FIG. 3, the engagement members 12 may have proximal end portions 12a corresponding to the front end 10A of the clip 10 and distal end portions 12b corresponding to the rear end 10B of the clip 10. The engagement members 12 may be connected to each other at the proximal end portions 12a thereof and extended from the proximal end portions 12a toward the distal end portions 12b (from the front end 10A of the clip 10 toward the front end 10A of the clip 10) along a central axis L of the clip 10. Further, the engagement members 12 may respectively be capable of elastically flexing (deforming) inwardly with respect to the central axis L about the connected proximal end portions 12a.

As shown in FIG. 3, the engagement members 12 may respectively be obliquely extended from the proximal end portions 12a while being inclined outwardly with respect to the central axis L of the clip 10, so as to form main portions. The engagement members 12 (the main portions) thus shaped may respectively have outwardly most-bulged portions positioned between the proximal end portions 12a and the distal end portions 12b, so as to form shoulder portions 12c therein. The engagement members 12 may then be relatively thinned and obliquely extended inwardly from the most-bulged portions (the shoulder portions 12c) toward the distal end portions 12b, so as to form inwardly inclined transition portions respectively having inclined surfaces 12d. The engagement members 12 may then be bent and vertically extended from the transition portions (the inclined surfaces 12d) to the distal end portions 12b, so as to form vertical arm portions 12e. Further, the engagement members 12 may respectively have inwardly oppositely projected protrusions 12f that are respectively formed in the distal end portions 12b.

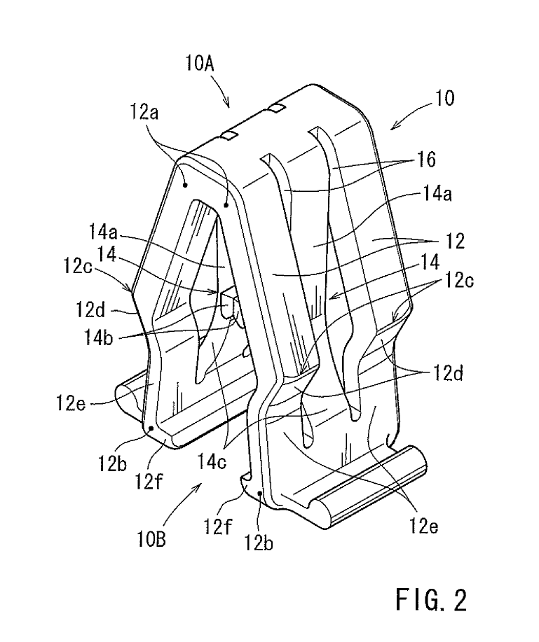

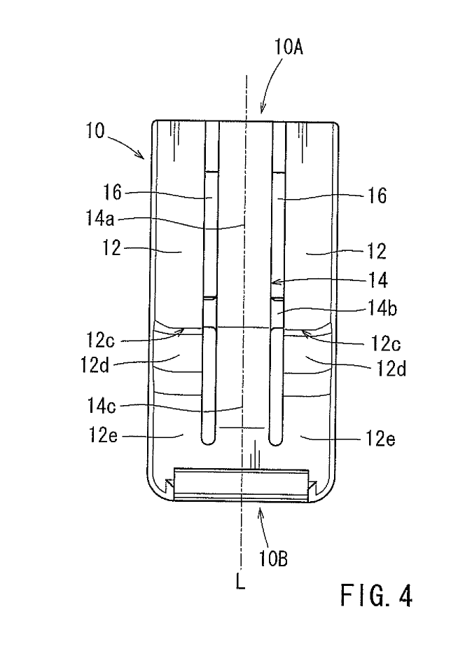

Conversely, the retainer members 14 may be formed as flexible strips that are respectively formed in the engagement members 12. In particular, as shown in FIGS. 2 and 4, a pair of vertically elongated slots 16 are formed in each of the engagement members 12 in parallel with each other. Thus, the retainer members 14 may respectively be integrally formed in the engagement members 12. Further, as shown in FIG. 4, the pair of elongated slots 16 may preferably be positioned such that each of the retainer members 14 can be formed in a (widthwise) central portion of each of the engagement members 12. Further, as shown in FIG. 3, each of the retainer members 14 may respectively be oppositely convexed inwardly.

As best shown in FIG. 2, the retainer members 14 thus formed may respectively be connected to the proximal end portions 12a of the engagement members 12 in the front end 10A of the clip 10 and the distal end portions 12b of the engagement members 12 in the rear end 10B of the clip 10. Thus, the retainer members 14 may respectively be connected to or integrated with the engagement members 12 in the front and rear ends 10A and 10B of the clip 10. Further, as previously described, each of the retainer members 12 may respectively be oppositely convexed inwardly. As a result, as shown in FIG. 3, the engagement members 12 and the retainer members 14 can be connected to each other so as to form a substantially rhombic loop in an elevational view of the clip 10.

Further, as shown in FIG. 3, the retainer members 14 may respectively include upper or front pressing portions 14a and lower or rear extended portions 14c. The pressing portions 14a may respectively be connected to the proximal end portions 12a of the engagement members 12 at one end thereof and extended substantially vertically therefrom along the central axis L. The extended portions 14c may respectively be extended from the other end of the pressing portions 14a and connected to the distal end portions 12b of the engagement members 12. Each of the pressing portions 14a has a thickness greater than a thickness of each of the extended portions 14c, so as to have a rigidity that is required to maintain a condition in which the clip 10 is coupled to the attachment portion 22 of the component 20. Further, the pressing portions 14a may preferably be configured (tapered) such that a distance between inner opposite surfaces thereof can be gradually reduced from the front end 10A of the clip 10 toward the rear end 10B of the clip 10.

Further, the retainer members 14 may respectively have inwardly projected engagement protrusions 14b that are respectively formed in lower end portions of the inner opposite surfaces of the pressing portions 14a thereof. As shown in FIG. 4, each of the engagement protrusions 14b may preferably have a width (a lateral length) greater than a width of each of the retainer members 14 in a side view of the clip 10, so as to be laterally projected beyond each of the pressing portions 14a.

As shown in FIG. 4, the retainer members 14 thus formed may respectively be spaced from the engagement members 12 via the elongated slots 16. In other words, the retainer members 14 may be configured to not be overlapped with the engagement members 12 in the side view of the clip 10. Therefore, when the engagement members 12 are elastically flexed inwardly about the proximal end portions 12a thereof, the engagement members 12 can be flexed or deformed independently of the retainer members 14, so as to be aligned with the retainer members 14 in the elevational view of the clip 10. Thus, when the clip 10 is inserted into the attaching hole 26 formed in the panel 24, a size or thickness of the clip 10 can be effectively reduced. As a result, the attaching hole 26 of the panel 24 can be relatively reduced in size.

An example of the component 20 is a center cluster that is integrally formed by plastic molding. The attachment portion 22 of the component 20 may preferably be integrally formed in a rear surface of the component 20. The attachment portion 22 may have a predetermined thickness, so as to be introduced between the inner opposite surfaces of the pressing portions 14a of the retainer members 14 of the clip 10. The attachment portion 22 may have an engagement slot 22a that is formed as a through bore passing therethrough. Further, the attachment portion 22 may have a pair of reinforcement ribs 22b that are respectively attached to opposite ends thereof.

An example of the panel 24 is an instrument panel. Further, the attaching hole 26 of the panel 24 may be formed as a through bore passing through the panel 24.

Next, a method of attaching the component 20 to the panel 24 using the clip 10 will now be described in detail.

First, the clip 10 is pressed toward the attachment portion 22 of the component 20 from the open rear end 10B thereof. As a result, the attachment portion 22 can be introduced between the inner opposite surfaces of the pressing portions 14a of the retainer members 14 of the clip 10. At the same time, the engagement protrusions 14b formed in the pressing portions 14a can engage the engagement slots 22a of the attachment portion 22. Thus, the clip 10 can be coupled to the attachment portion 22 of the component 20.

As previously described, the pressing portions 14a of the retainer members 14 is configured such that the distance between the inner opposite surfaces thereof can be gradually reduced from the front end 10A of the clip 10 toward the rear end 10B of the clip 10. Therefore, even if the thickness of the attachment portion 22 may be varied, the pressing portions 14a can reliably clamp the attachment portion 22 therebetween, so that the clip 10 can be securely coupled to the attachment portion 22 without producing backlash therebetween. Further, each of the engagement protrusions 14b is laterally projected beyond each of the pressing portions 14a. Therefore, even if each of the retainer members 14 has a limited width in the side view of the clip 10, the engagement protrusions 14b can engage the engagement slots 22a of the attachment portion 22 over a considerable or sufficient distance.

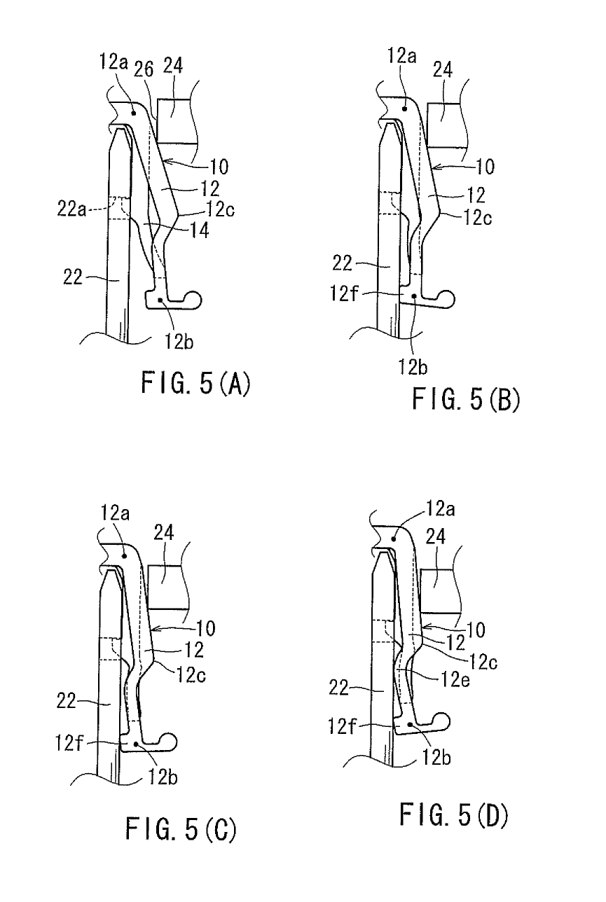

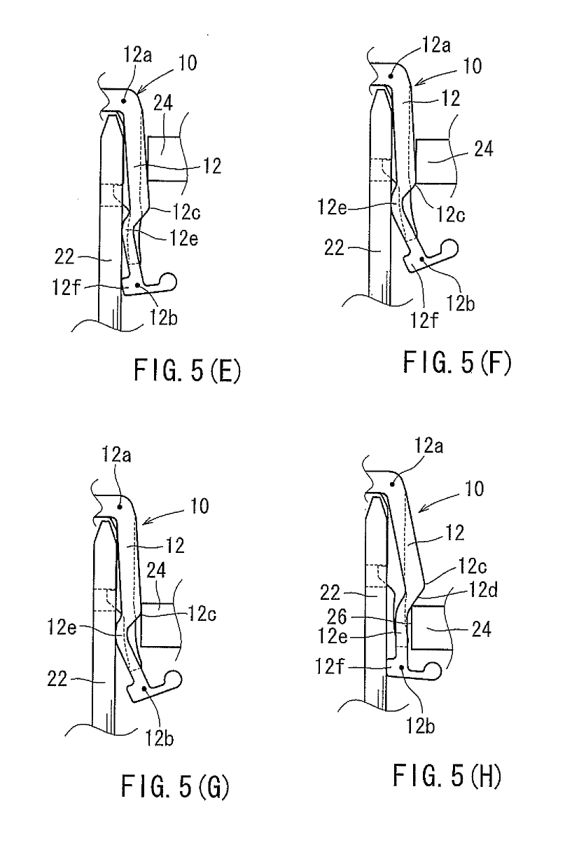

Thereafter, the clip 10 coupled to the attachment portion 22 of the component 20 may be pushed into the attaching hole 26 formed in the panel 24. As a result, as shown in FIGS. 5(A) to 5(G), which correspond to first to seventh stages of a clip insertion operation, the engagement members 12 may be progressively introduced into the attaching hole 26 while they are elastically flexed inwardly about the proximal end portions 12a thereof due to pressing forces applied by a periphery of the attaching hole 26. As shown in FIG. 5(H), which corresponds to an eighth stage of the clip insertion operation, when the outwardly most-bulged portions (the shoulder portion 12c) of the engagement members 12 (the main portions) pass through the attaching hole 26, the engagement members 12 can be restored or flexed outwardly, so that the inclined surfaces 12d (the transition portions) continuous with the shoulder portion 12c can engage the periphery of the attaching hole 26. This condition may be referred to as an engagement condition of the engagement members 12. As a result, the engagement members 12 can be securely received in the attaching hole 26, so that the clip 10 can be connected to the panel 24. Thus, the component 20 can be attached to the panel 24 via the clip 10.

In particular, when the engagement members 12 are introduced into the attaching hole 26 from a condition shown in FIG. 5(A) to a condition shown in FIG. 5(B), the engagement members 12 may be elastically flexed inwardly about the proximal end portions 12a thereof, so that the protrusions 12f formed in the distal end portions 12b of the engagement members 12 can contact the attachment portion 22 of the component 20 (FIG. 5(B)). When the engagement members 12 are further introduced into the attaching hole 26 from a condition shown in FIG. 5(C) to a condition shown in FIG. 5(D), the engagement members 12 may be continuously flexed inwardly, so that the arm portions 12e of the engagement members 12 can contact the attachment portion 22 while the distal end portions 12b (the protrusions 12f) contact the attachment portion 22. That is, the distal end portions 12b and the arm portions 12e of the engagement members 12 can successively contact the attachment portion 22 in the middle of a clip insertion operation (i.e., before the outwardly most-bulged portions of the engagement members 12 pass through the attaching hole 26).

When the engagement members 12 are further introduced into the attaching hole 26 from a condition shown in FIG. 5(E) to a condition shown in FIG. 5(G), the engagement members 12 may be further continuously flexed inwardly while the arm portions 12e contact the attachment portion 22. At this time, as shown in FIGS. 5(F) and 5(G), the transition portions of the engagement members 12 can also be gradually deformed or flexed, so that the distal end portions 12b (the protrusions 120 can be spaced from the attachment portion 22. As shown in FIG. 5(H), when the engagement members 12 are further introduced into the attaching hole 26, i.e., when the outwardly most-bulged portions (the shoulder portion 12c) of the engagement members 12 pass through the attaching hole 26, the engagement members 12 can be restored or flexed outwardly about the proximal end portions 12a thereof, so that the inclined surfaces 12d (the transition portions) can engage the periphery of the attaching hole 26. At this time, the arm portions 12e can be spaced from the attachment portion 22. At the same time, the transition portions of the engagement members 12 can be restored, so that the distal end portions 12b (the protrusions 12f) can contact the attachment portion 22 again.

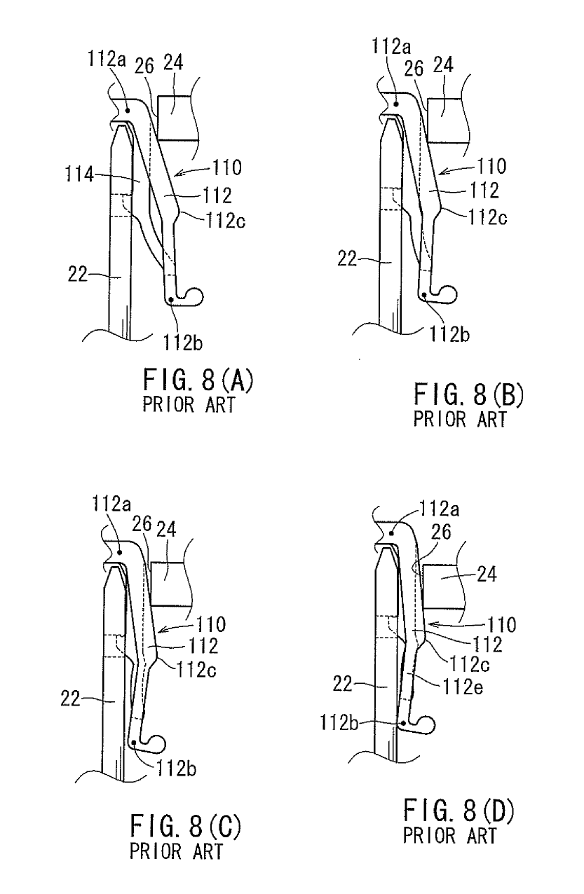

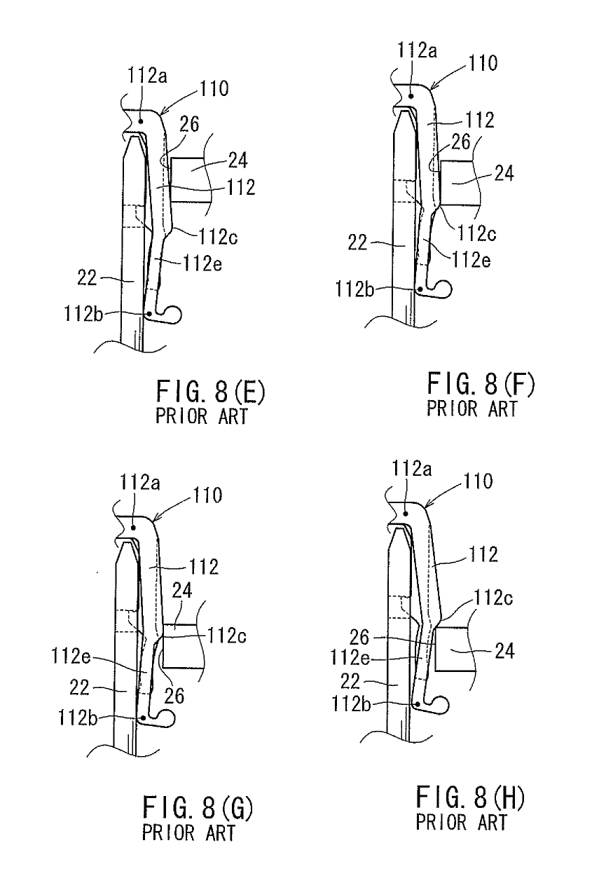

To the contrary, as shown in FIGS. 8(A) to 8(H), which correspond to FIGS. 5(A) to 5(H), in the conventional clip 110, when the engagement members 112 are introduced into the attaching hole 26 from a condition shown in FIG. 8(A) to a condition shown in FIG. 8(D), the engagement members 112 may be elastically flexed inwardly about the proximal end portions 112a thereof, so that the distal end portions 112b of the engagement members 112 can contact the attachment portion 22 of the component 20 (FIG. 8(D)). In other words, the distal end portions 112b cannot contact the attachment portion 22 of the component 20 until the engagement members 112 reaches the condition shown in FIG. 8(D). At this time, unlike the clip 10 of the present embodiment, the arm portions 112e of the engagement members 112 cannot contact the attachment portion 22.

When the engagement members 112 are further introduced into the attaching hole 26 from a condition shown in FIG. 8(E) to a condition shown in FIG. 8(G), the engagement members 112 may be continuously flexed inwardly while the distal end portions 112b contact the attachment portion 22. At this time, unlike the clip 10 of the present embodiment, the arm portions 112e of the engagement members 112 cannot contact the attachment portion 22. Also, the distal end portions 112b cannot be spaced from the attachment portion 22. When the engagement members 112 are further introduced into the attaching hole 26 to a condition shown in FIG. 8(H), i.e., when the outwardly most-bulged portions of the engagement members 112 pass through the attaching hole 26, the engagement members 112 can be restored or flexed outwardly about the proximal end portions 112a thereof, so that the shoulder portions 112c can engage the periphery of the attaching hole 26.

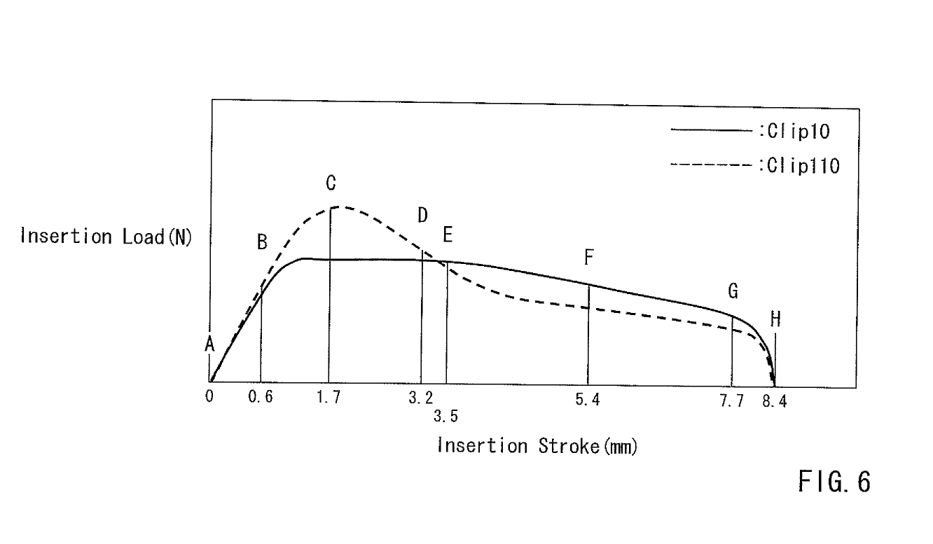

Characteristics of the clip 10 and the conventional clip 110 are shown in FIG. 6. In FIG. 6, a characteristic curve of the clip 10 is shown by solid line. Conversely, a characteristic curve of the conventional clip 110 is shown by broken line. Each of these characteristic curves in FIG. 6 is shown as a curve which shows a relation between an insertion distance or insertion stroke (mm) and an insertion load (N). Further, references characters A to H respectively show insertion strokes, which correspond to the conditions shown in FIG. 5(A) to 5(H) and FIG. 8(A) to 8(H).

As shown by solid line in FIG. 6, the characteristic curve of the clip 10 may be substantially flattened from immediately after initiation of the clip insertion operation (i.e., after the insertion stroke B) to immediately before completion of the clip insertion operation or immediately before the engagement condition of the engagement members 12 (i.e., around the insertion stroke G) without forming a peak therebetween. That is, an insertion load of the clip 10 may be maintained substantially constant without forming a peak from immediately after initiation of the clip insertion operation to immediately before completion of the clip insertion operation. Further, the insertion load may be sharply lowered from the insertion stroke G and reduced to zero in the insertion stroke H (in the engagement condition of the engagement members 12).

To the contrary, as shown by broken line in FIG. 6, the characteristic curve of the conventional clip 110 may have a peak around the insertion stroke C. That is, an insertion load of the clip 110 may be changed significantly from around the insertion stroke B to around the insertion stroke E and may have the peak around the insertion stroke C. The insertion load may be sharply reduced after the insertion stroke C and may be maintained substantially constant from around the insertion stroke E to around the insertion stroke G.

According to the clip 10, unlike the conventional clip 110, the insertion load of the clip 10 can be maintained substantially constant from the initiation of the clip insertion operation to the completion of the clip insertion operation because the engagement members 12 are configured such that the distal end portions 12b and the arm portions 12e thereof can successively contact the attachment portion 22 in the middle of the clip insertion operation. Therefore, workers can be prevented from being overburdened. As a result, working efficiency of the clip insertion operation can be increased.

Further, the insertion load of the clip 10 may substantially depend on elastic forces of the engagement members 12. Conversely, the elastic force of the engagement members 12 may substantially correspond to a retaining force of the clip 10. Therefore, the insertion load of the clip 10 can be maintained substantially constant over the substantially all insertion strokes without reducing the retaining force of the clip 10.

Further, when the clip insertion operation is completed (i.e., when the engagement members 12 reach the engagement condition), the engagement members 12 can be restored or flexed outwardly, so that the arm portions 12e can be spaced from the attachment portion 22. As a result, the insertion load can be sharply reduced. Therefore, a feeling of snap action at the completion of the clip insertion operation can be increased.

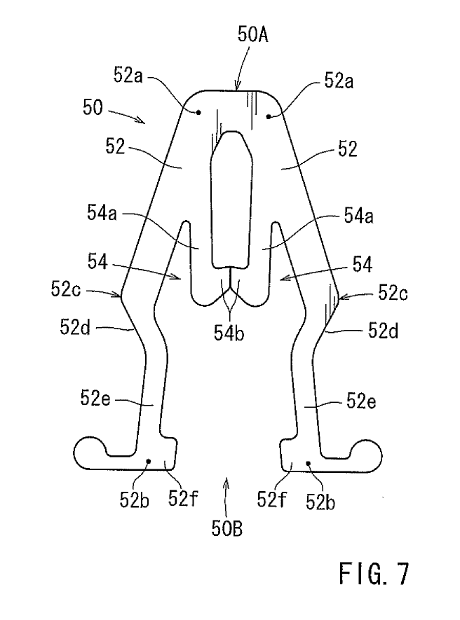

The second detailed representative embodiment will now be described in detail with reference to FIG. 7. Because the second embodiment relates to the first embodiment, only the constructions and elements that are different from the first embodiment will be explained in detail.

Similar to the clip 10, the clip 50 may have a closed upper or front (leading) end 50A and an open lower or rear (trailing) end 50B. In particular, the clip 50 may essentially be composed of a pair of right and left flexible engagement members 52 and a pair of retainer members 54. Similar to the engagement members 12 of the clip 10, the engagement members 52 may have proximal end portions 52a corresponding to the front end 50A of the clip 50 and distal end portions 52b corresponding to the rear end 50B of the clip 50. The engagement members 52 may be connected to each other at the proximal end portions 52a thereof. Further, the engagement members 52 may respectively be capable of elastically flexing (deforming) inwardly about the connected proximal end portions 52a.

The engagement members 52 may respectively have outwardly most-bulged portions respectively having shoulder portions 52c, inclined transition portions respectively having inclined surfaces 52d, vertical arm portions 52e, and protrusions 52f, which respectively correspond to the outwardly most-bulged portions having the shoulder portions 12c, the inclined transition portions respectively having inclined surfaces 12d, the vertical arm portions 12e, and the protrusions 12f of the engagement members 12 of the clip 10.

Conversely, the retainer members 54 may be formed as flexible strips that are respectively formed in the engagement members 52. Unlike the retainer members 14 of the clip 10, the retainer members 54 may respectively be integrally connected to inner surfaces of the engagement members 52. Unlike the retainer members 14 of the clip 10, the retainer members 54 may respectively include only upper or front pressing portions 54a that are formed as cantilevered portions. Further, the retainer members 54 may respectively have inwardly projected engagement protrusions 54b that are respectively formed in lower end portions of inner opposite surfaces of the pressing portions 54a thereof.

Naturally, various changes and modifications may be made to the present invention without departing from the scope of the invention. For example, in the embodiments, the clip 10 is composed of the two flexible engagement members 12 and the two flexible retainer members 14. However, the clip 10 can be composed of a single flexible engagement member and a single flexible retainer member. That is, one of the flexible engagement members 12 and one of the flexible retainer members 14 can be replaced with a non-flexible rigid member.

Representative examples of the present invention have been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

What is claimed is:

1. A clip made of resin, the clip being configured to be coupled to an attachment portion formed in an attaching component and configured to be inserted into an attaching hole formed in a panel, so as to attach the component to the panel, comprising:
a closed front end that functions as a leading end when the clip is inserted into the attaching hole,
an open rear end,
an engagement member extended from the front end of the clip toward the rear end of the clip and having a proximal end portion corresponding to the front end of the clip and a distal end portion corresponding to the rear end of the clip,
and
a retainer member formed in the engagement member and configured to be secured to the attachment portion of the component,
wherein the engagement member has an outwardly bulged portion that is positioned between the proximal end portion and the distal end portion thereof so as to form a shoulder portion therein, and an arm portion that is positioned between the shoulder portion and the distal end thereof,
wherein the engagement member is configured to be elastically deformed inwardly about the proximal end portion,
wherein the engagement member is configured such that when the engagement member is introduced into the attaching hole of the panel, the distal end portion and the arm portion thereof can successively contact the attachment portion of the component due to elastic deformation of the engagement member before the shoulder portion of the engagement member passes through the attaching hole, and
wherein the engagement member is configured to engage a periphery of the attaching hole when the shoulder portion of the engagement member passes through the attaching hole.

2. The clip as defined in claim 1, wherein the engagement member is configured such that the arm portion can continuously contact the attachment portion of the component until immediately before the shoulder portion of the engagement member passes through the attaching hole.

3. A clip configured to be coupled to an attachment portion formed in an attaching component and configured to be inserted into an attaching hole formed in a panel, comprising:
a closed front end,
an open rear end,
an engagement member extended from the front end of the clip toward the rear end of the clip and having a proximal end portion corresponding to the front end of the clip and a distal end portion corresponding to the rear end of the clip,
and
a retainer members formed in the engagement member and configured to be secured to the attachment portion of the component,
wherein the engagement member includes a main portion having an outwardly bulged portion, a transition portion obliquely extended inwardly from the outwardly bulged portion of the main portion, and an arm portion extended from the transition portion.

4. The clip as defined in claim 3, wherein the engagement member has an inwardly projected protrusion that is formed in the distal end portion.
